(19) United States
(12) Patent Application Publication
(10) Pub. No.: US 2026/0029238 A1
(43) Pub. Date: Jan. 29, 2026

(54) SYSTEMS AND METHODS FOR MONITORING, DETECTING, ANALYZING, AND INFORMING ABNORMAL CELLULAR RADIO-FREQUENCY CHARACTERISTICS

(71) Applicant: Ford Global Technologies, LLC, Dearborn, MI (US)

(72) Inventors: Krishna Bandi, Novi, MI (US); Muhammad Murad Shahnawaz, West Bloomfield, MI (US); Muhammad Zarak Khan, Novi, MI (US); Michael Weidel, Livonia, MI (US); Mario Anthony Santillo, Canton, MI (US)

(73) Assignee: Ford Global Technologies, LLC, Dearborn, MI (US)

(21) Appl. No.: 18/782,687

(22) Filed: Jul. 24, 2024

(51) Int. Cl. G01C 21/34; H04B 17/345; H04B 17/391

(52) U.S. Cl. CPC G01C 21/3453; H04B 17/345; H04B 17/391

(57) ABSTRACT

A method includes the monitoring of one or more marshaling-related characteristics, the detection of at least one cellular-related disruption corresponding to a cell of a plurality of cells associated with a marshaling environment, the analysis of the one or more marshaling-related characteristics associated with the at least one cellular-related disruption, and the receipt of an adjustment to one or more marshaling commands.

### FIELD

The present disclosure relates to marshaling a vehicle. More specifically, the present disclosure relates to marshaling a vehicle based on live reporting of a condition of cellular connectivity within a marshaling environment.

### BACKGROUND

The statements in this section merely provide background information related to the present disclosure and may not constitute prior art.

Vehicles are monitored in typical marshaling environments by an infrastructure system reliant on wireless connectivity, such as cellular-related protocols. However, such a reliance on the cellular-related protocols can be disruptive at least based on network congestion, packet delays, interference on related channels from other communication systems, degradation of signal strength from aging hardware, or a combination thereof. Additionally, sporadic and/or untimely network surveys can result in these disruptions causing delays and/or unexpected stops of marshaled vehicles within the marshaling environment. The present disclosure addresses these and other issues related to the marshaling of vehicles based on a cellular-related protocol.

### SUMMARY

This section provides a general summary of the disclosure and is not a comprehensive disclosure of its full scope or all of its features.

The present disclosure provides a method comprising: monitoring, by a vehicle-marshaling algorithm of a vehicle, one or more marshaling-related characteristics based on an exchange of one or more messages with an infrastructure system; detecting at least one cellular-related disruption corresponding to a cell of a plurality of cells associated with a marshaling environment, wherein the detection of the at least one cellular-related disruption is associated with the one or more marshaling-related characteristics; analyzing the one or more marshaling-related characteristics associated with the at least one cellular-related disruption based on one or more marshaling commands; and receiving an adjustment to the one or more marshaling commands based on the analysis, wherein a traverse of the vehicle is adjusted based on the receipt of the adjustment to the one or more marshaling commands; wherein the one or more marshaling-related characteristics include unicast wireless frequencies associated with the vehicle, a plurality of cell identifiers associated with the plurality of cells, radio frequency-related performance metrics, or a combination thereof; wherein the at least one cellular-related disruption includes degradation of a live communication link between the vehicle and the infrastructure system, an interference associated with the live communication link, or a combination thereof; further comprising: transmitting, from the vehicle via a live communication link, the analysis of the one or more marshaling-related characteristics to the infrastructure system, wherein the transmission of the analysis is simultaneous to the traverse of the vehicle across the marshaling environment; wherein the analysis of the one or more marshaling-related characteristics further comprises: verifying a location of the vehicle based on coordinates of the location of the vehicle matching snap-shot data associated with the location of the vehicle, wherein the snap-shot data is obtained from one or more vehicle sensors; and causing, in response to the verification of the location of the vehicle, a time-stamp and a virtual dynamic radio-frequency coverage heat map of the at least one cellular-related disruption to be generated; wherein the adjustment to the one or more marshaling commands is received in response to a disruption-related threshold being exceeded; and wherein the adjustment to the one or more marshaling commands includes control-time-based marshaling, waypoints-based marshaling, message transmission rates, a velocity of the vehicle, a curvature of the traverse of the vehicle, a spacing buffer associated with the vehicle or a combination thereof.

The present disclosure provides a system comprising: a vehicle system configured to: monitor, by a vehicle-marshaling algorithm of a vehicle, one or more marshaling-related characteristics based on an exchange of one or more messages with an infrastructure system, detect at least one cellular-related disruption corresponding to a cell of a plurality of cells associated with a marshaling environment, wherein the detection of the at least one cellular-related disruption is associated with the one or more marshaling-related characteristics, analyze the one or more marshaling-related characteristics associated with the at least one cellular-related disruption based on one or more marshaling commands, and receive an adjustment to the one or more marshaling commands based on the analysis, wherein a traverse of the vehicle is adjusted based on the receipt of the adjustment to the one or more marshaling commands; the infrastructure system configured to: receive the analysis of the one or more marshaling-related characteristics, generate a time-stamp and a virtual dynamic radio-frequency coverage heat map of the at least one cellular-related disruption, and transmit the one or more adjustments to the one or more marshaling commands to the vehicle system; and a mobile network operator configured to: receive the analysis of the one or more marshaling-related characteristics via an original equipment manufacturing cloud system, and repair the at least one cellular-related disruption; wherein the one or more marshaling-related characteristics are analyzed via one or more of latency one-way, round-trip time, inter-packet gap, congestion, reference-signal-received-power, reference-signal-received-quality, signal-to-interference-plus-noise-ratio, interference, packet-loss, through-put, start-and-end associated with physical cell identifiers, frequency channels and bands monitoring indoors and outdoors, cell identifiers, start-and-end evolved-node-Bs, and wherein the one or more marshaling-related characteristics include unicast wireless frequencies associated with the vehicle, a plurality of cell identifiers associated with the plurality of cells, radio frequency-related performance metrics, or a combination thereof; wherein the at least one cellular-related disruption includes degradation of a live communication link between the vehicle and the infrastructure system, an interference associated with the live communication link, or a combination thereof; wherein the vehicle system is further configured to: transmit, from the vehicle via a live communication link, the analysis of the one or more marshaling-related characteristics to the infrastructure system, wherein the transmission of the analysis is simultaneous to the traverse of the vehicle across the marshaling environment; wherein the vehicle system configured to analyze the one or more marshaling-related characteristics is further configured to: verify a location of the vehicle based on coordinates of the location of the vehicle matching snap-shot data associated with the location of the vehicle, wherein the snap-shot data is obtained from one or more vehicle sensors; and cause, in response to the verification of the location of the vehicle, a time-stamp and a virtual dynamic radio-frequency coverage heat map of the at least one cellular-related disruption to be generated; wherein the adjustment to the one or more marshaling commands is received in response to a disruption-related threshold being exceeded; and wherein the adjustment to the one or more marshaling commands includes control-time-based marshaling, waypoints-based marshaling, message transmission rates, a velocity of the vehicle, a curvature of the traverse of the vehicle, a spacing buffer associated with the vehicle or a combination thereof.

The present disclosure provides one or more non-transitory computer-readable media storing processor-executable instructions that, when executed by at least one processor, cause the at least one processor to: monitor, by a vehicle-marshaling algorithm of a vehicle, one or more marshaling-related characteristics based on an exchange of one or more messages with an infrastructure system; detect at least one cellular-related disruption corresponding to a cell of a plurality of cells associated with a marshaling environment, wherein the detection of the at least one cellular-related disruption is associated with the one or more marshaling-related characteristics; analyze the one or more marshaling-related characteristics associated with the at least one cellular-related disruption based on one or more marshaling commands; and receive an adjustment to the one or more marshaling commands based on the analysis, wherein a traverse of the vehicle is adjusted based on the receipt of the adjustment to the one or more marshaling commands; wherein the one or more marshaling-related characteristics are analyzed via one or more of latency one-way, round-trip time, inter-packet gap, congestion, reference-signal-received-power, reference-signal-received-quality, signal-to-interference-plus-noise-ratio, interference, packet-loss, through-put, start-and-end associated with physical cell identifiers, frequency channels and bands monitoring indoors and outdoors, cell identifiers, start-and-end evolved-node-Bs, and wherein the one or more marshaling-related characteristics include unicast wireless frequencies associated with the vehicle, a plurality of cell identifiers associated with the plurality of cells, radio frequency-related performance metrics, or a combination thereof; wherein the at least one cellular-related disruption includes degradation of a live communication link between the vehicle and the infrastructure system, an interference associated with the live communication link, or a combination thereof; wherein the at least one processor is further caused to: transmit, from the vehicle via a live communication link, the analysis of the one or more marshaling-related characteristics to the infrastructure system, wherein the transmission of the analysis is simultaneous to the traverse of the vehicle across the marshaling environment; wherein the at least one processor caused to analyze the one or more marshaling-related characteristics is further caused to: verify a location of the vehicle based on coordinates of the location of the vehicle matching snap-shot data associated with the location of the vehicle, wherein the snap-shot data is obtained from one or more vehicle sensors; and cause, in response to the verification of the location of the vehicle, a time-stamp and a virtual dynamic radio-frequency coverage heat map of the at least one cellular-related disruption to be generated; and wherein the adjustment to the one or more marshaling commands is received in response to a disruption-related threshold being exceeded, and wherein the adjustment to the one or more marshaling commands includes control-time-based marshaling, waypoints-based marshaling, message transmission rates, a velocity of the vehicle, a curvature of the traverse of the vehicle, a spacing buffer associated with the vehicle or a combination thereof.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a system for automated vehicle marshaling in accordance with one or more embodiments of the present disclosure;

FIG. 2 illustrates an example vehicle distributed by the system shown in FIG. 1 in accordance with one or more embodiments of the present disclosure;

FIG. 3 illustrates a system for monitoring, detecting, analyzing, and/or providing information associated with any abnormal cellular radio-frequency characteristics associated with one or more locations of a marshaling environment in accordance with one or more embodiments of the present disclosure;

FIG. 4 illustrates an implementation of a system for automated vehicle marshaling in accordance with one or more embodiments of the present disclosure;

FIG. 5 is a flowchart illustrating an example method for monitoring, detecting, analyzing, and/or providing information associated with any abnormal cellular radio-frequency characteristics associated with one or more locations of a marshaling environment in accordance with one or more embodiments of the present disclosure; and

FIG. 6 is a block diagram illustrating an example computer system in accordance with one or more embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

One or more herein described examples provide a robust wireless networking communication network that is configured to mitigate common-factors that can contribute to a poor connectivity environment, such as temperature/humidity extremes, machinery-induced power disturbances, electrical noise, long cable-runs, and/or vibrations; and/or continuous reconfiguration of installation environments in support of new product lines and/or technologies.

In one or more example embodiments, such a robust wireless networking communication network can provide a mechanism for manufacturing plant operations to quickly and efficiently identify such contributing factors to poor connectivity. The robust wireless networking communication network can also provide mechanism(s) for plant operators to quickly resolve such contributing factors to poor connectivity. The mechanism(s) used is based on a live virtual heat map of network connectivity reported by marshaled vehicles that is continuously updated as the vehicles are marshaled across the networking environment. As an example, such mechanism(s) can be used within depot marshaling warehouses, and/or underground parking lots with limited network connectivity to assist in valet-parking. It is understood, however, that such mechanism(s) can be used within any marshaling environment.

Such mechanism(s), in one or more example embodiments, also provide continuous feedback information to mobile network operators regarding the provided service that is received by the marshaled vehicles. Such communication with the mobile network operators results in enhanced cellular service to client-offered programs associated with the vehicle beyond marshaling of the vehicle such as internet and radio services.

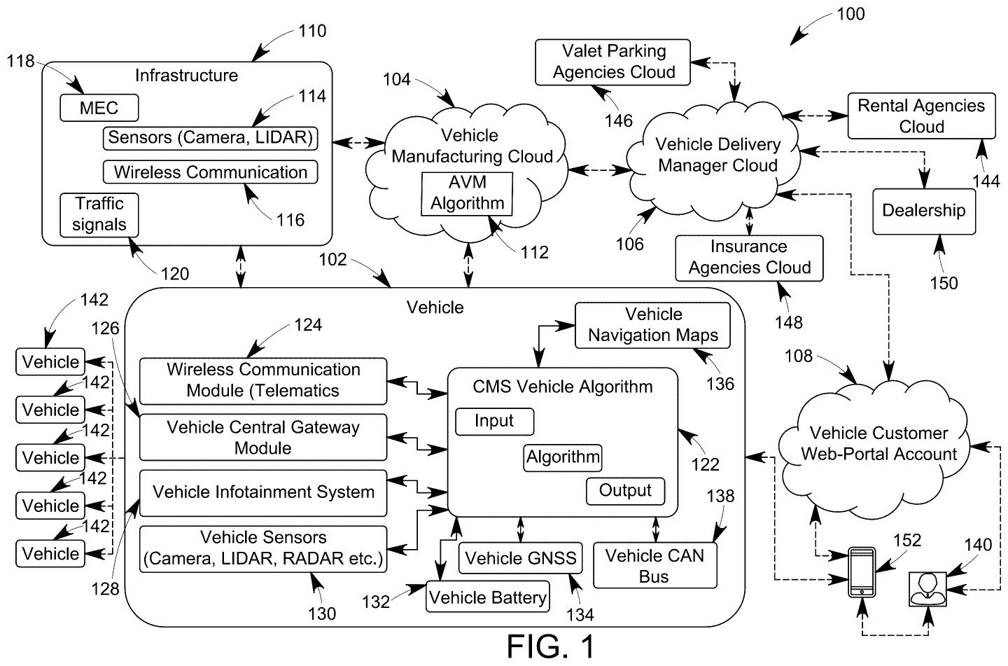

FIG. 1 shows a schematic block diagram illustrative of an automated vehicle marshaling (AVM) system 100. In one or more examples, the AVM system 100 marshals one or more vehicles (e.g., a vehicle 102) traveling at a low speed. However, it is understood that the AVM system 100 may marshal the one or more vehicles traveling at any speed. It is also understood that the AVM system 100 may marshal semi-autonomous vehicles and/or fully autonomous vehicles.

The AVM system 100 generally includes the vehicle 102, a vehicle manufacturing cloud system 104, a vehicle delivery manager cloud system 106, a vehicle customer web-portal account cloud system 108, and an infrastructure system 110. The vehicle manufacturing cloud system 104 operates as the central cloud system that manages and/or facilitates any manufacturing process associated with the vehicle 102. The vehicle manufacturing cloud system 104 is configured to wirelessly communicate with the vehicle delivery manager cloud system 106 and/or the infrastructure system 110. The vehicle manufacturing cloud system 104 is also configured to wirelessly communicate with the vehicle 102.

The vehicle manufacturing cloud system 104 can include an infrastructure-side AVM algorithm 112. The infrastructure-side AVM algorithm 112 processes status information associated with at least the vehicle 102 of the one or more vehicles. It is understood that the infrastructure-side AVM algorithm 112 processes status information associated with each vehicle of the one or more vehicles (e.g., the vehicle 102). The vehicle manufacturing cloud system 104 is configured to cause the infrastructure system 110 to monitor the progression of the one or more vehicles (e.g., the vehicle 102) as the vehicle(s) progress through a marshaling environment (e.g., a factory floor or parking lot). The vehicle manufacturing cloud system 104 is also configured to cause the infrastructure system 110 to communicate with the one or more vehicles. For example, the vehicle manufacturing cloud system 104 utilizes the infrastructure-side AVM algorithm 112 to send instructions to the infrastructure system 110 and/or to process information received from the infrastructure system 110. The vehicle manufacturing cloud system 104 is also configured to cause the vehicle delivery manager cloud system 106 to facilitate a delivery of the one or more vehicles (e.g., the vehicle 102) to various locations. For example, the vehicle manufacturing cloud system 104 utilizes the infrastructure-side AVM algorithm 112 to send instructions to the vehicle delivery manager cloud system 106 and/or to process information received from the vehicle delivery manager cloud system 106.

The vehicle manufacturing cloud system 104 is further configured to communicate directly with the one or more vehicles to cause the one or more vehicles to start, stop, or pause progression through the marshaling environment. The vehicle manufacturing cloud system 104 is further configured to control a marshaling speed of the one or more vehicles as the one or more vehicles travel through (e.g., traverse) the marshaling environment. For example, the vehicle manufacturing cloud system 104 utilizes the infrastructure-side AVM algorithm 112 to send instructions to the vehicle 102 and/or to process information received from the vehicle 102.

The infrastructure system 110 includes a sensor component 114, a wireless communication component 116, a multi-access edge computing (MEC) system 118, and one or more traffic signals 120. It is understood that the MEC system 118 is configured to support communication between the wireless communication component 116 and the vehicle 102. It is understood, however, that the MEC system 118 is also configured to support communication between the wireless communication component 116 and any of the vehicle manufacturing cloud system 104, the vehicle delivery manager cloud system 106, and/or the vehicle customer web-portal account cloud system 108. For example, the wireless communication component 116 may utilize GPS, Wi-Fi, satellite, 3G/4G/5G, and/or Bluetooth™ to communicate with the one or more vehicles.

The wireless communication component 116 also communicates with the sensor component 114 that is configured to manage, for example, one or more of cameras, lidar, radar, and/or ultrasonic devices. The sensor component 114 monitors the movement of the one or more vehicles as the vehicle(s) are marshaled through the marshaling environment. Additionally, the wireless communication component 116 also communication with the traffic signals 120. For example, the wireless communication component 116 may cause the traffic signals 120 to direct traffic of the one or more vehicles as the one or more vehicles are marshaled through the marshaling environment. It is understood that the infrastructure system 110 can forward instructions received from the vehicle manufacturing cloud system 104 to the vehicle 102. However, it is also understood that the infrastructure system 110 can send instructions to the vehicle 102 directly through the utilization of the MEC system 118, for example.

The vehicle 102 includes a vehicle-side AVM algorithm 122, a wireless transmission module 124, a vehicle central gateway module 126, a vehicle infotainment system 128, one or more vehicle sensors 130, a vehicle battery 132, a vehicle global navigation satellite (e.g., GNSS) 134, a vehicle navigation mapping system 136, and a controller area network (CAN) vehicle bus 138. The wireless transmission module 124 may be a transmission control unit (TCU) and/or may be supported by telematically supported subsystems. The wireless transmission module 124 includes one or more sensors that are configured to gather data and send signals to other components of the vehicle 102. The one or more sensors of the wireless transmission module 124 may include a vehicle speed sensor (not shown) configured to determine a current speed of the vehicle 102; a wheel speed sensor (not shown) configured to determine if the vehicle 102 is traveling at an incline or a decline; a throttle position sensor (not shown) determines if a downshift or upshift of one or more gears associated with the vehicle 102 is required in a current status of the vehicle 102; and/or a turbine speed sensor (not shown) configured to send data associated with a rotational speed of a torque converter of the vehicle 102.

The wireless transmission module 124 communicates information, gathered by the one or more sensors, to the vehicle-side AVM algorithm 122. In one embodiment, the vehicle-side AVM algorithm 122 may be disposed as a component within the wireless transmission module 124. For example, the vehicle 102 utilizes the vehicle-side AVM algorithm 122 to process and send information gathered by the one or more sensors to the infrastructure system 110. As another example, the vehicle 102 utilizes the vehicle-side AVM algorithm 122 to process and send information gathered by the one or more sensors to the vehicle manufacturing cloud system 104 directly. The vehicle-side AVM algorithm 122 is configured to communicate information and/or instructions to the wireless transmission module 124 received from the infrastructure system 110 and/or the vehicle manufacturing cloud system 104.

The vehicle central gateway module 126 operates as an interface between various vehicle domain bus systems, such as an engine compartment bus (not shown), an interior bus (not shown), an optical bus for multimedia (not shown), a diagnostic bus for maintenance (not shown), or the vehicle CAN bus 138. The vehicle central gateway module 126 is configured to distribute data communicated to the vehicle central gateway module 126 by each of the various domain bus systems to other components of the vehicle 102. The vehicle central gateway module 126 is also configured to distribute information received from the vehicle-side AVM algorithm 122 to the various domain bus systems. The vehicle central gateway module 126 is further configured to send information to the vehicle-side AVM algorithm 122 received from the various domain bus systems. For example, the vehicle 102 utilizes the vehicle-side AVM algorithm 122 to process and send information received from the vehicle central gateway module 126 to the infrastructure system 110. As another example, the vehicle 102 utilizes the vehicle-side AVM algorithm 122 to process and send information received from the vehicle central gateway module 126 to the vehicle manufacturing cloud system 104 directly. The vehicle-side AVM algorithm 122 is configured to communicate information and/or instructions to the vehicle central gateway module 126 received from the infrastructure system 110 and/or the vehicle manufacturing cloud system 104.

The vehicle infotainment system 128 delivers a combination of information and entertainment content and/or services to a user 140 of the vehicle 102. It is understood that the vehicle infotainment system 128 can deliver only entertainment content to the user 140 of the vehicle 102, in some examples. It is also understood that the vehicle infotainment system 128 can deliver information services to anyone associated with the vehicle 102, in other examples. As an example, the vehicle infotainment system 128 includes built-in car computers that combine one or more functions, such as digital radios, built-in cameras, and/or televisions. The vehicle infotainment system 128 communicates information associated with the built-in car computers or processors to the vehicle-side AVM algorithm 122. For example, the vehicle 102 utilizes the vehicle-side AVM algorithm 122 to process and send information received from the vehicle infotainment system 128 to the infrastructure system 110. As another example, the vehicle 102 utilizes the vehicle-side AVM algorithm 122 to process and send information received from the vehicle infotainment system 128 to the vehicle manufacturing cloud system 104 directly. The vehicle-side AVM algorithm 122 is configured to communicate information and/or instructions to the vehicle infotainment system 128 received from the infrastructure system 110 and/or the vehicle manufacturing cloud system 104.

The one or more vehicle sensors 130 may be, for example, one or more of cameras, lidar, radar, and/or ultrasonic devices. For example, ultrasonic devices utilized as the one or more vehicle sensors 130 emit a high frequency sound wave that hits an object (e.g., a wall or another vehicle) and is then reflected back to the vehicle 102. Based on the amount of time it takes for the sound wave to return to the vehicle 102, the vehicle 102 can determine the distance between the one or more vehicle sensors 130 and the object. As another example, camera devices utilized as the one or more vehicle sensors 130 provide a visual indication of a space around the vehicle 102. As an additional example, radar devices utilized as the one or more vehicle sensors 130 emit electromagnetic wave signals that hit the object and is then reflected back to the vehicle 102. Based on the amount of time it takes for the electromagnetic waves to return to the vehicle 102, the vehicle 102 can determine a range, velocity, and angle of the vehicle 102 relative to the object.

The one or more vehicle sensors 130 communicate information associated with the position and/or distance at which the vehicle 102 is relative to the object to the vehicle-side AVM algorithm 122. For example, the vehicle 102 utilizes the vehicle-side AVM algorithm 122 to process and send information received from the one or more vehicle sensors 130 to the infrastructure system 110. As another example, the vehicle 102 utilizes the vehicle-side AVM algorithm 122 to process and send information received from the one or more vehicle sensors 130 to the vehicle manufacturing cloud system 104 directly. The vehicle-side AVM algorithm 122 is configured to communicate information and/or instructions to the one or more vehicle sensors 130 received from the infrastructure system 110 and/or the vehicle manufacturing cloud system 104.

The vehicle battery 132 is controlled by a battery management system (not shown) that provides instructions to the vehicle battery 132. For example, the battery management system provides instructions to the vehicle battery 132 based on a temperature of the vehicle battery 132. However, it is understood that the battery management system may provide instructions to the vehicle battery 132 based on any measure associated with the vehicle battery 132 such as power state of the vehicle 102, a time period of at least one day that the vehicle 102 is in an off-state, or a combination thereof. The battery management system ensures acceptable current modes of the vehicle battery 132. For example, the acceptable current modes protect against overvoltage, overcharge, and/or overheating of the vehicle battery 132. As another example, the temperature of the vehicle battery 132 indicates to the battery management system whether any of the acceptable current modes are within acceptable temperate ranges. The battery management system associated with the vehicle battery 132 communicates information associated with the temperature of the vehicle battery 132 to the vehicle-side AVM algorithm 122. For example, the vehicle 102 utilizes the vehicle-side AVM algorithm 122 to process and send information received regarding the vehicle battery 132 to the infrastructure system 110. As another example, the vehicle 102 utilizes the vehicle-side AVM algorithm 122 to process and send information regarding the vehicle battery 132 to the vehicle manufacturing cloud system 104 directly. The vehicle-side AVM algorithm 122 is configured to communicate information and/or instructions to the vehicle battery 132 received from the infrastructure system 110 and/or the vehicle manufacturing cloud system 104.

The vehicle GNSS 134 is configured to communicate with satellites so that the vehicle 102 can determine a specific location of the vehicle 102. The vehicle navigation mapping system 136 can display, via a display screen (not shown), the specific location of the vehicle 102 to the user 140. The vehicle GNSS 134 communicates geographical information associated with the vehicle 102 to the vehicle-side AVM algorithm 122. For example, the vehicle 102 utilizes the vehicle-side AVM algorithm 122 to process and send information received from the vehicle GNSS 134 to the infrastructure system 110. As another example, the vehicle 102 utilizes the vehicle-side AVM algorithm 122 to process and send information from the vehicle GNSS 134 to the vehicle manufacturing cloud system 104 directly. The vehicle-side AVM algorithm 122 is configured to communicate information and/or instructions to the vehicle GNSS 134 received from the infrastructure system 110 and/or the vehicle manufacturing cloud system 104. As another example, the vehicle 102 utilizes the vehicle-side AVM algorithm 122 to process and send information associated with the vehicle navigation mapping system 136 to the infrastructure system 110. As another example, the vehicle 102 utilizes the vehicle-side AVM algorithm 122 to process and send information from the vehicle navigation mapping system 136 to the vehicle manufacturing cloud system 104 directly. The vehicle-side AVM algorithm 122 is configured to communicate information and/or instructions to the vehicle navigation mapping system 136 received from the infrastructure system 110 and/or the vehicle manufacturing cloud system 104.

The vehicle 102 is configured to communicate any information associated with any of the components included within the vehicle 102 to one or more additional vehicles 142. The vehicle 102 is also configured to communicate (e.g., forward) any instructions received from the infrastructure system 110 and/or the vehicle manufacturing cloud system 104 to any of the one or more additional vehicles 142. For example, the vehicle's 102 communication with the one or more additional vehicles 142 can aid the infrastructure system 110 and/or the vehicle manufacturing cloud system 104 in marshaling the one or more additional vehicles 142. It is understood that each of the one or more additional vehicles 142 can include any of the components described as being included within the vehicle 102, such as a vehicle-side AVM algorithm, a wireless transmission module, a vehicle central gateway module, a vehicle infotainment system, one or more vehicle sensors, a vehicle battery, a vehicle GNSS system, a vehicle navigation mapping system, and/or a CAN vehicle bus, for example. It is also understood that any of the one or more additional vehicles 142 is configured to communicate information associated with any of the components included therein with the vehicle 102. It is further understood that the one or more additional vehicles 142 can also be configured to establish a direct line of wireless communication (e.g., via a communication link) with the infrastructure system 110 and/or the vehicle manufacturing cloud system 104, whereby information can be directly exchanged between the one or more additional vehicles 142 and the infrastructure system 110 and/or the vehicle manufacturing cloud system 104.

The vehicle delivery manager cloud system 106 wirelessly communicates (e.g., receives and/or sends instructions and/or information) with one or more of a rental agencies cloud system 144, a valet parking agencies cloud system 146, an insurance agencies cloud system 148, and/or a dealership system 150. The vehicle delivery manager cloud system 106 is configured to facilitate the delivery of the one or more vehicles to any of a rental agency (not shown) associated with the rental agencies cloud system 144, a valet parking agency (not shown) associated with the valet parking agencies cloud system 146, an insurance agency (not shown) associated with the insurance agencies cloud system 148, and/or the dealership system 150. The vehicle delivery manager cloud system 106 also wirelessly communicates with the vehicle customer web-portal account cloud system 108. It should be understood that other cloud systems can be included, in one or more examples.

The delivery manager cloud system 106 wirelessly communicates with a user device 152 such as a mobile device, a display panel, and/or a computer. The vehicle 102 is also configured to wirelessly communicate directly with the user device 152. For example, the user 140 engages with the user device 152 via an application that organizes any information and/or instructions received from the vehicle customer web-portal account cloud system 108 and/or the vehicle 102. As another example, the user 140 may send one or more instructions to the vehicle customer web-portal account cloud system 108 such as making a selection of which vehicle the user 140 would like to receive from any of the rental agency associated with the rental agencies cloud system 144, the valet parking agency associated with the valet parking agencies cloud system 146, the insurance agency associated with the insurance agencies cloud system 148, and/or the dealership system 150.

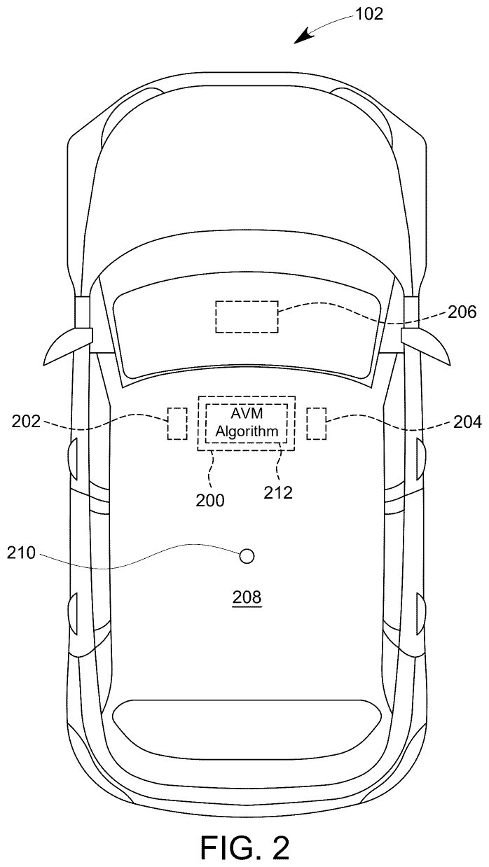

Referring to FIG. 2, in various forms, the vehicle(s) 102 may be powered in a variety of ways, for example, with an electric motor and/or an internal combustion engine. It is understood that the vehicle(s) 102 may be any type of vehicle powered by an electric motor and/or an internal combustion engine such as a car, a truck, a robot, a plane, and/or a boat. The vehicle(s) 102 generally include the vehicle controller 200, one or more actuators 202, a plurality of on-board sensors 204, a human machine interface (HMI) 206, and a vehicle system 208. The vehicle(s) 102 also has a reference point 210, that is, a specified point within a space defined by a vehicle body that identifies the location of the vehicle(s) 102. For example, the reference point 210 is a geometrical center point at which respective longitudinal and lateral center axes of the vehicle(s) 102 intersects. As another example, the reference point 210 is a point at which the vehicle(s) 102 is located as the vehicle(s) 102 navigates toward a waypoint.

The vehicle controller 200, in some examples, is configured or programmed to control the operation of one or more of vehicle brakes, propulsion (e.g., control of acceleration in the vehicle(s) 102 by controlling one or more of an internal combustion engine, electric motor, hybrid engine, etc.), steering, climate control, interior and/or exterior lights, etc. The vehicle controller 200, in other examples, is further configured or programed to determine whether and when the vehicle controller 200, as opposed to a human operator, is to control such operations related to the vehicle(s) 102. It is understood that any of the operations associated with the vehicle(s) 102 may be facilitated via an automated, a semi-automated, or a manual mode. For example, the automated mode may facilitate any of the operations to be fully controlled by the vehicle controller 200 without the aid of the human operator. As another example, the semi-automated mode may facilitate any of the operations to be at least partially controlled by the human operator in combination with the vehicle controller 200. As a further example, the manual mode may facilitate the operations to be fully controlled by the human operator without the aid of the vehicle controller 200.

The vehicle controller 200 includes, or may be communicatively coupled to (e.g., via a vehicle communications bus), one or more processors (not shown). For example, the one or more processors can be a controller, or the like, included in the vehicle(s) 102 for monitoring and/or controlling various vehicle controllers, such as a powertrain controller, a brake controller, a steering controller, etc. The vehicle controller 200 is generally arranged for communications on a vehicle communication network (not shown) that can include a bus in the vehicle(s) 102 such as a controller area network (CAN), or the like, and/or other wired and/or wireless mechanisms.

Via a vehicle network, the vehicle controller 200 transmits messages to various devices in the vehicle(s) 102 and/or receives messages from the various devices, for example, the one or more actuators 202, the HMI 206, etc. Alternatively, or additionally, in cases where the vehicle controller 200 includes Multiple devices, the vehicle communication network is utilized for communications between devices represented as the vehicle controller 200 in this disclosure. Further, as discussed below, various other controllers and/or sensors provide data to the vehicle controller 200 via the vehicle communication network.

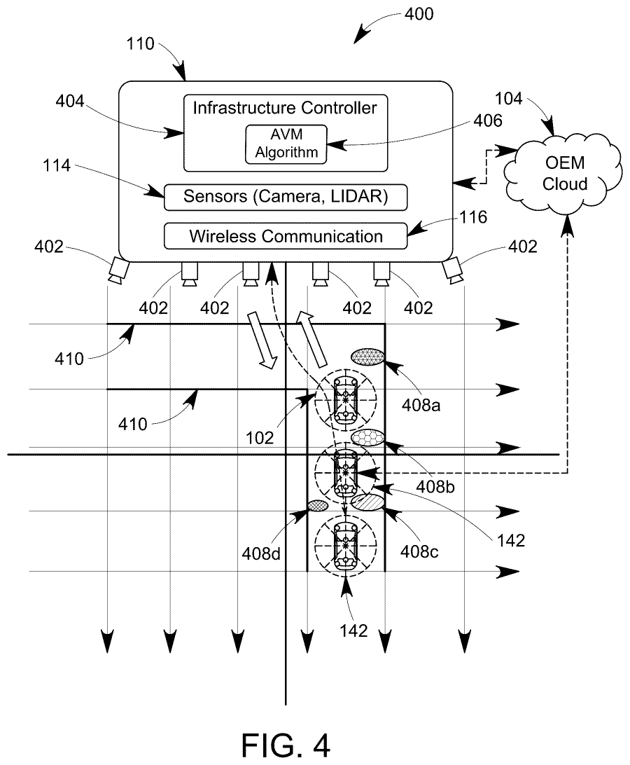

In addition, the vehicle controller 200, via a vehicle-side AVM algorithm 212, is configured for communicating through a vehicle-to-infrastructure communication network, such as communicating with an infrastructure controller (e.g., an infrastructure controller 404 as shown in FIG. 4). The vehicle controller 200, via the vehicle-side AVM algorithm 212, is also configured for communicating through a wireless vehicular communication interface with other traffic objects (e.g., vehicles, infrastructures, etc.), such as, via a vehicle-to-vehicle communication network. The vehicular communication network represents one or more mechanisms by which the vehicle controller 200 of the vehicle(s) 102 communicates with other traffic objects. As an example, the vehicular communication network may be one or more of wireless communication mechanisms, including any desired combination of wireless (e.g., cellular, wireless, satellite, microwave, and/or radio frequency) communication mechanisms and any desired network topology (or topologies when multiple communication mechanisms are utilized). Examples of vehicular communication networks include, among others, cellular, Bluetooth®, EEE 802.11, dedicated short range communications (DSRC), and/or wide area networks (WAN), including the Internet, providing data communication services.

The one or more actuators 202 are implemented via circuits, chips, or other electronic and/or mechanical components that can actuate various vehicle subsystems in accordance with appropriate control signals. The one or more actuators 202 may be used to control braking, acceleration, and/or steering of the vehicle(s) 102. The vehicle controller 200 can be programmed to activate the one or more actuators 202 including propulsion, steering, and/or braking based on the planned acceleration or deceleration of the vehicle(s) 102.

The plurality of on-board sensors 204 include a variety of devices to provide data to the vehicle controller 200. For example, the plurality of on-board sensors 204 may include object detection sensors (e.g., lidar sensor(s)) disposed on or in the vehicle(s) 102 that provide relative locations, sizes, and/or shapes of one or more objects surrounding the vehicle(s) 102, such as additional vehicles, bicycles, robots, drones, etc., travelling next to, ahead, and/or behind the vehicle(s) 102. As another example, one or more of the plurality of on-board sensors 204 can be radar sensors affixed to one or more bumpers of the vehicle(s) 102 that may provide locations of the object(s) relative to the location of each of the vehicles 102.

The plurality of on-board sensors 204 may include a camera sensor, for example, to provide a front view, side view, rear view, etc., providing images from an area surrounding the vehicle(s) 102. As another example, the vehicle controller 200 may be programmed to receive sensor data from a camera sensor(s) and to implement image processing techniques to detect a road, infrastructure elements, etc. The vehicle controller 200 may be further programmed to determine a current vehicle location based on location coordinates (e.g., GPS coordinates) received from the vehicle(s) 102 indicative of a location of the vehicles' 102 location from a GPS sensor (not shown).

The HMI 206 is configured to receive information from the human operator during operation of the vehicle(s) 102. Moreover, the HMI 206 is configured to present information to the human operator, such as, an occupant of the vehicle(s) 102. In some variations, the vehicle controller 200 is programmed to receive destination data (e.g., location coordinates) from the HMI 206.

The vehicle system 208 is configured to control each of the subsystems within the vehicle(s) 102 and facilitate requests across each of the above-described components (e.g., the vehicle controller 200, the one or more actuators 202, the plurality of on-board sensors 204, and/or the HMI 206). Accordingly, the vehicle(s) 102 can be autonomously guided toward a waypoint using at least the plurality of on-board sensors 204. Routing can be performed using vehicle location, distance to travel, queue in line for vehicle marshaling, etc.

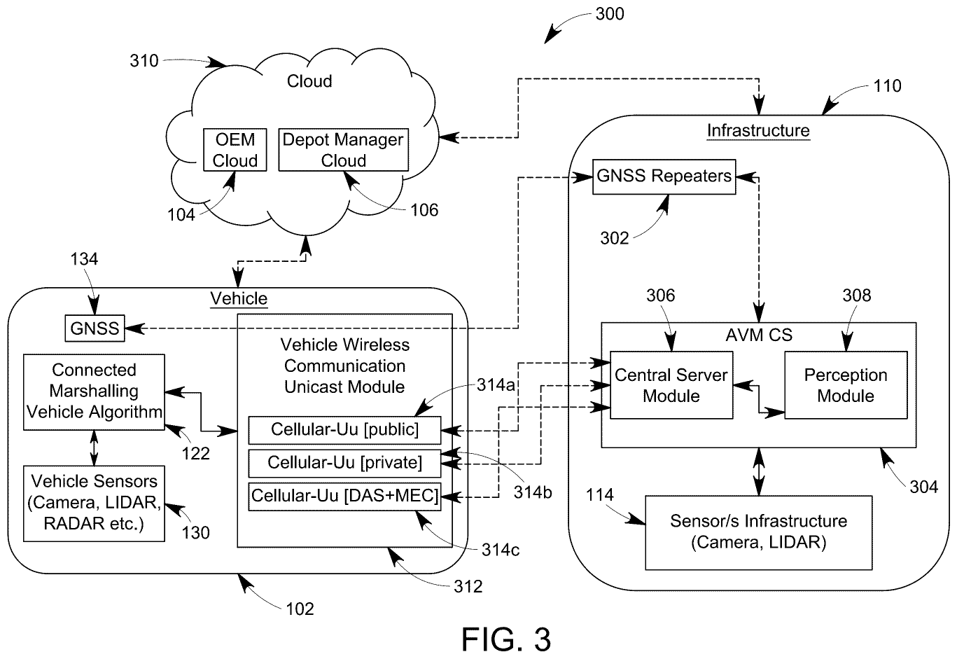

In another embodiment, FIG. 3, shows a system 300 configured to facilitate communication between the vehicle 102 and the infrastructure system 110. For example, the system 300 provides a means for the monitoring, detection, analysis, and/or informing of any abnormal cellular radio-frequency (e.g., RF) characteristics present within the marshaling environment. It is understood, however, that the system 300 may provide a means for the monitoring, detection, analysis, and/or informing of any abnormal characteristics associated with any cellular related-protocols used in association with the marshaling environment. Generally, the infrastructure system 110 communicates with the vehicle 102 using one of two means, either via a cellular protocol or a secure wireless protocol. It is understood that the infrastructure system 110 may communicate with the vehicle 102 by any other means such as via an RF-related communication protocol. It is also understood that the secure wireless protocol may include and/or be sent via a CV2X-PC5 protocol. However, it is further understood that any secure communicative protocol may be used.

The infrastructure system 110, as illustrated in FIG. 3, generally includes at least one GNSS repeater 302, an AVM central server 304, and the sensor component 114. The AVM central server 304 operates as the central server of the infrastructure system 110 that utilizes a central server module 306 and/or a perception module 308 to process communication ultimately received from each of the vehicle-side AVM algorithm 122 and/or a server cloud 310. The central server module 306 is configured to communicate directly with one or more wireless communication modules 314 (e.g., a public cellular module 314a; a private cellular module 314b; and/or a cellular module supported by a distributed antenna system (e.g., DAS) and/or an MEC 314c) of a vehicle wireless communication unicast module 312. For example, the central server module 306 is configured to communicate with the one or more wireless communication modules 314 by utilizing a wireless CV2X-PC5 protocol to initiate and/or maintain a marshaling flow (e.g., via a communication link) associated with an onboarding, offboarding, and/or re-onboarding of the vehicle 102 with the infrastructure system 110. It is also understood that the central server module may be communicatively coupled (e.g., via wireless or wired means) to the perception module 308.

The perception module 308 is configured to process and/or interpret sensor data obtained by the sensor component 114 to detect, identify, classify, and/or track the vehicle 102 and/or the one or more additional vehicles 142 as they move through the marshaling environment. The perception module 308 is further configured to develop a three-dimensional model of the marshaling environment based on the sensor data obtained by the sensor component 114 and/or sensor data received from the vehicle 102 (e.g., originating from the one or more vehicle sensors 130). The perception module 308 is additionally configured to analyze any of the identified interference-inflicted and/or degradable locations (e.g., one or more trouble spots 408a-408d as shown in FIG. 4) that are associated with the abnormal cellular RF characteristics. For example, interference related issues may arise based on, but are not limited to, interference on related channels from other communication systems. As another example, degradation issues may arise based on, but are not limited to, a weakened signal strength resultant from aging hardware. The at least one GNSS repeater 302 is configured to wirelessly receive one or more GNSS signals received directly from the vehicle GNSS 134. For example, the one or more GNSS signals aid the perception module 308 it its development of the three-dimensional model, thereby supporting the obtained sensor data.

The vehicle 102, as illustrated in FIG. 3, generally includes the vehicle-side AVM algorithm 122, the one or more vehicle sensors 130, the vehicle GNSS 134, and the vehicle wireless communication unicast module 312. The one or more sensors 130 can be configured to detect any abnormal cellular RF characteristics present within the marshaling environment. Based on the one or more vehicle sensors' 130 detection of any abnormal cellular RF characteristics present within the marshaling environment, the vehicle-side AVM algorithm 122 installed on the vehicle 102 is utilized to aid in the monitoring, detection, analysis, and/or informing of any abnormal cellular RF characteristics present within the marshaling environment to provide the infrastructure system 110 with information associated with interference-inflicted and/or degradable locations across the manufacturing environment.

The infrastructure system 110 is configured to transmit one or more instructions (e.g., one or more marshaling commands) to the vehicle 102 based on the identified interference-inflicted and/or degradable locations. As another example, the one or more marshaling commands can cause the vehicle 102 to be marshaled in a manner that will result in the vehicle 102 maneuvering around the identified interference-inflicted and/or degradable locations. In other words, the one or more marshaling commands can provide the vehicle 102 with a new set of one or more waypoints to follow that causes the vehicle 102 to move around the identified interference-inflicted and/or degradable locations that are associated with the abnormal cellular RF characteristics. For example, the vehicle 102 can receive the one or more marshaling commands at the vehicle wireless communication unicast module 312 via the public cellular module 314a, the private cellular module 314, and/or the cellular module supported by the DAS and/or the MEC 314c.

The vehicle 102 may also communicate information associated with the detection of any abnormal cellular RF characteristics present within the marshaling environment to the server cloud 310. The server cloud 310 includes the original equipment manufacturer cloud system (e.g., the vehicle manufacturing cloud system 104) and the depot manager cloud system (e.g., the vehicle delivery manager cloud system 106). Additionally, the infrastructure system 110 may also communicate any information associated with any of the identified interference-inflicted and/or degradable locations that are associated with the abnormal cellular RF characteristics to the server cloud 310.

In another embodiment, FIG. 4 shows a system 400 configured to provide a means for monitoring, detecting, analyzing, and/or providing information associated with any abnormal cellular RF characteristics associated with one or more locations of the marshaling environment. More specifically, the system 400 provides such a means for monitoring, detecting, analyzing, and/or providing information associated with any abnormal cellular RF characteristics based on communication between the vehicle 102 (e.g., and/or the one or more additional vehicles 142), the vehicle manufacturing cloud system 104, and the infrastructure system 110.

In one or more embodiments, the communication between the vehicle 102 (e.g., and/or the one or more additional vehicles 142), the vehicle manufacturing cloud system 104, and the infrastructure system 110 is supported by the exchange of one or more infrastructure marshaling messages (IMMs) and one or more vehicle marshaling messages (VMMs). For example, information associated with monitoring, detecting, analyzing, and/or providing information associated with any abnormal cellular RF characteristics that corresponds to interference-inflicted and/or degradable locations across the manufacturing environment is communicated via an extended RF live reporting protocol originating at the vehicle 102 and/or the one or more additional vehicles 142. As another example, the RF live reporting protocol can dynamically reflect various locations and details associated with the marshaling environment via one or more operational adjustments to the vehicle 102 and/or the one or more additional vehicles 142. As a further example, the one or more operation adjustments can cause the vehicle 102 and/or the one or more additional vehicles 142 to maneuver around areas and/or object(s) (e.g., vehicle(s), an infrastructure, etc.) associated with of the manufacturing environment that may result in a stoppage of the vehicle 102 and/or the one or more additional vehicles 142.

The infrastructure system 110 includes the sensor component 114 that communicates with a set of infrastructure sensors 402 such as, for example, one or more cameras, lidar, radar, and/or ultrasonic devices. The set of infrastructure sensors 402 are configured to monitor the movement of the vehicle 102 and/or the one or more additional vehicles 142 as the vehicle 102 and/or the one or more additional vehicles 142 as moves through the marshaling environment. The infrastructure system 110 also includes the wireless communication component 116 that provides for communication between the infrastructure system 110 and the vehicle 102 and/or the one or more additional vehicles 142.

Additionally, the infrastructure system 110 includes the infrastructure controller 404. The infrastructure controller 404 is configured to centrally control an operation of the vehicle 102 and/or the one or more additional vehicles 142. For example, the operation of the vehicle 102 and/or the one or more additional vehicles 142 include propulsion, braking, and/or steering of the vehicle 102 and/or the one or more additional vehicles 142. It is understood that the infrastructure controller 404 may be disposed within the infrastructure system 110 or externally located relative to the infrastructure system 110. The infrastructure controller 404 includes an AVM software module 406 (e.g., an infrastructure-side AVM algorithm 406) that is configured to facilitate communication between the infrastructure controller 404 and the vehicle controller 200 associated with the vehicle 102 and/or the one or more additional vehicles 142.

For example, and in one or more embodiments, the vehicle's 102 movement through the manufacturing environment is monitored based on the exchange of the one or more VMMs and the one or more IMMs between the vehicle 102 and the infrastructure system 110. As an additional example, the one or more VMMs and the one or more IMMs can include messages such as request—requestresponse; command—commandresponse, query—queryresponse, alert—alertresponse, as well as any other messages associated with the marshaling of the vehicle 102 and/or the one or more additional vehicles 142. As yet another example, the one or more VMMs and the one or more IMMs can comprise of messages associated with a request for longer trajectory control time based marshaling; one or more waypoints based marshaling; IMM and/or VMM transmission rates; a vehicle velocity; curvature; a required buffer between each of the vehicle 102 and the one or more additional vehicles 142, or a combination thereof.

As another example, the one or more additional vehicles' 142 movements through the manufacturing environment is also monitored based on the exchange of the one or more VMMs and the one or more IMMs between the one or more additional vehicles 142 and the infrastructure system 110. However, it is understood that the one or more additional vehicles' 142 movements through the manufacturing environment can also be monitored based on an exchange of VMMs directly with the vehicle 102. It is additionally understood that the vehicle-side AVM algorithm 122 is configured to monitor the movement of the vehicle 102 and/or the one or more additional vehicles 142 itself. For example, the vehicle-side AVM algorithm 122 is configured to be internally aware of which RF frequencies, physical cell identifiers, and/or RF performance metrics of the physical cell identifiers are expected within a geo-fenced area 410. As another example, the vehicle-side AVM algorithm 122 is also configured to determine whether the RF frequencies, physical cell identifiers, and/or the RF performance metrics of the physical cell identifiers match or exceed the expectation with the geo-fenced area 410 based on a regression evaluation and/or validation used as baseline inputs.

As a further example, one or more characteristics associated with the vehicle 102 and/or the one or more additional vehicles 142 can be monitored in addition to the movement of the vehicle 102 and/or the one or more additional vehicles 142. As yet another example, the one or more characteristics can include wireless frequencies transmitted by the vehicle 102 and/or the one or more additional vehicles 142 (e.g., via a unicast or broadcasted means); physical cell identifiers associated with the manufacturing environment adjacent a current location of the vehicle 102 and/or the one or more additional vehicles 142; RF performance metrics associated with the vehicle 102 and/or the one or more additional vehicles 142 as well as the adjacent current location of the vehicle 102 and/or the one or more additional vehicles 142; or a combination thereof.

The vehicle 102 and/or the one or more additional vehicles 142 may utilize the one or more vehicle sensors 130 and/or RF signal-mapping characteristics to detect the one or more trouble spots 408a-408d. As an example, the vehicle 102 and/or the one or more additional vehicles 142 can detect the one or more trouble spots 408a-408d based on a change in a frequency latch and/or a change in physical cell identifiers as received from one or more neighboring cells. As an additional example, the vehicle 102 and/or the one or more additional vehicles 142 can further detect the one or more trouble spots 408a-408d based on a change in a frequency latch and/or a change in physical cell identifiers associated with RF performance where there is any intermittent effect starting on the automated marshaling protocol by an increase in the latency, round-trip time (RTT), interpacket gap (IPG), congestion, additional reception of the neighboring physical cell identifiers, degradation in the signal strength (e.g., received signal strength indicator (RSSI), reference signal received power (RSRP), reference signal received quality (RSRQ)), the signal-to-interference-to-noise ratio (e.g., SINR), packet loss, throughput, and/or any other marshaling-related metric or operational characteristic. As yet another example, the vehicle 102 and/or the one or more additional vehicles 142 can detect any degradation in performance when the vehicle 102 and/or the one or more additional vehicles 142 has respective cells and a shifting/latching/un-latching protocol begins to affect a level of degradation in the performance associated with any unknown neighboring cells. The vehicle 102 and/or the one or more additional vehicles 142 can also detect shift patterns associated with the physical cell identifiers of the manufacturing environment at different times in a day, for example.

The vehicle 102 and/or the one or more additional vehicles 142 may also utilize the vehicle-side AVM algorithm 122 to analyze (e.g., process) information received from the one or more vehicle sensors 130 and/or RF signal-mapping characteristics associated with the one or more trouble spots 408a-408d. For example, the vehicle-side AVM algorithm 122 may analyze the information associated with the one or more trouble spots 408a-408d based on a function associated with the detection of the one or more trouble spots 408a-408d and its associated RF performance. As another example, the function can be representative of latency one-way; RTT; IPG; RSRP; RSRQ; RSSI; SINR; interference; packet-loss; throughput; start/end physical cell identifiers; frequency channels and bands monitoring of indoors/outdoors; cell identifiers; and/or start/end evolvednodeBs (eNBs). It is understood that the function can be representative of any other value associated with the detection of the one or more trouble spots 408a-408d and its associated RF performance, however.

The vehicle 102 and/or the one or more additional vehicles 142 are configured to alert (e.g., inform) the infrastructure system 110 and/or the vehicle manufacturing cloud system 104 of the one or more trouble spots 408a-408d as the vehicle 102 and/or the one or more additional vehicles 142 are marshaled through the marshaling environment. For example, the alert may be transmitted (e.g., via the one or more VMMs) to the infrastructure system 110 and/or the vehicle manufacturing cloud system 104 via a live reporting protocol. In other words, the location of the one or more trouble spots 408a-408d are reported by the vehicle 102 and/or the one or more additional vehicles 142 in real-time (e.g., live). It is understood, however, that the location of the one or more trouble spots 408a-408d may be reported by the vehicle 102 and/or the one or more additional vehicles 142 at regular or irregular time-related intervals, for example. It is also understood that upon receipt of the alert at the vehicle manufacturing cloud system 104, the vehicle manufacturing cloud system 104 may forward information associated with the alert to one or more mobile network operators (not shown). For example, the one or more mobile network operators can take one or more actions to remediate the interference and/or degradation associated with the one or more trouble spots 408a-408d.

In one or more embodiments, the vehicle 102 and/or the one or more additional vehicles 142 may be configured to evaluate whether the interference and/or degradation associated with the one or more trouble spots 408a-408d exceed a performance threshold. As a further example, in an instance wherein the performance threshold is exceeded, the vehicle 102 and/or the one or more additional vehicles 142 transmit the location of the one or more trouble spots 408a-408d to the infrastructure system 110 and/or the vehicle manufacturing cloud system 104. It is understood that the performance threshold may be any predefined value associated with successful marshaling of the vehicle 102 and/or the one or more additional vehicles 142 through the marshaling environment.

In one or more embodiments, the infrastructure system 110 is configured to utilize the infrastructure-side AVM algorithm 406 to generate a virtual dynamic real-time heat map indicative of each of the one or more trouble spots 408a-408d. For example, the generation of the virtual dynamic real-time heat map is based on the alert. As another example, the alert can include information associated with RF-performance-related metrics, a current position of the vehicle 102 and/or the one or more additional vehicles 142, one or more timestamps, snap-shot data or a combination thereof. As yet another example, the infrastructure-side AVM algorithm is configured to pair coordinates (e.g., X-, Y-, and or Z-coordinates) with at least the snap-shot data and the one or more timestamps to generate the virtual dynamic real-time heat map.

As a further example, the snap-shot data can originate from the one or more vehicle sensors 130. The virtual dynamic real-time heat map can be displayed on a user device (e.g., the user device 152) so that a system operator (e.g., the user 140) may view the marshaling environment therefrom. As an example, the one or more trouble spots 408a-408d can be represented by varying shades and/or colors that are indicative of a severity of the interference and/or degradation of the cellular connectivity in a particular area associated with the marshaling environment. It is understood that the system operator may be able to send instructions via the user device that can cause one or more operational adjustments to the vehicle 102 and/or the one or more additional vehicles 142. It is also understood that the vehicle-side AVM algorithm 122 can be configured to also generate a virtual dynamic real-time heat map in the same manner by which the infrastructure-side AVM algorithm 406 is configured to do so.

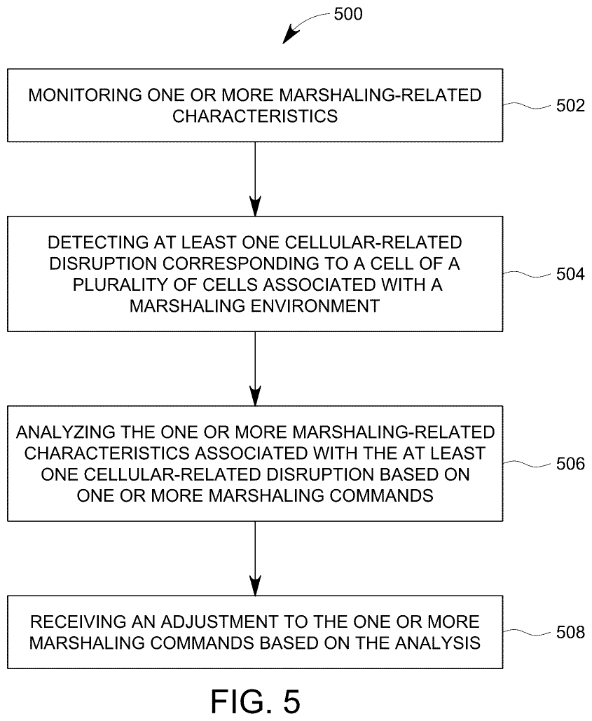

FIG. 5 is a flowchart illustrating an example method 500 for monitoring, detecting, analyzing, and/or providing information associated with any abnormal cellular RF characteristics associated with one or more locations of a marshaling environment (e.g., a factory floor or parking lot). For example, the one or more locations associated with abnormal cellular RF characteristics corresponds to interference-inflicted and/or degradable locations across the manufacturing environment. At operation 502, one or more marshaling-related characteristics are monitored. For example, the one or more marshaling-related characteristics are monitored by a vehicle-marshaling algorithm (e.g., the vehicle-side AVM algorithm 122) of a vehicle (e.g., the vehicle 102). As another example the monitoring of the one or more marshaling-related characteristics is based on an exchange of one or more messages with an infrastructure system (e.g., the infrastructure system 110). As a further example, the one or more marshaling-related characteristics include unicast wireless frequencies associated with the vehicle, a plurality of cell identifiers associated with the plurality of cells, radio frequency-related performance metrics, or a combination thereof.

At operation 504, at least one cellular-related disruption is detected. For example, the at least one cellular-related disruption (e.g., the abnormal cellular RF characteristics) corresponds to a cell of a plurality of cells associated with the marshaling environment. As another example, the detection of the at least one cellular-related disruption is associated with the one or more marshaling-related characteristics. As a further example, the at least one cellular-related disruption includes degradation of a live communication link between the vehicle and the infrastructure system, an interference associated with the live communication link, or a combination thereof.

At operation 506, the one or more marshaling-related characteristics is analyzed. For example, the one or more marshaling-related characteristics is associated with the at least one cellular-related disruption. As another example, the analysis of the one or more marshaling-related characteristics is based on one or more marshaling commands. As a further example, the analysis of the one or more marshaling-related characteristics includes a verification of a location of the vehicle. As yet another example, the verification of the location of the vehicle is based on coordinates of the location of the vehicle matching snap-shot data associated with the location of the vehicle. As an additional example, the snap-shot data is obtained from one or more vehicle sensors (e.g., the one or more vehicle sensors 130). Additionally, the analysis of the one or more marshaling-related characteristics also includes causing a time-stamp and/or a virtual dynamic RF coverage heat map of the at least one cellular-related disruption to be generated, for example. As another example, causing the time-stamp and/or the virtual dynamic RF coverage heat map of the at least one cellular-related disruption to be generated is performed in response to the verification of the location of the vehicle.

At operation 508, an adjustment to the one or more marshaling commands is received. For example, the adjustment to the one or more marshaling commands is received based on the analysis. As another example, a traverse of the vehicle is adjusted based on the receipt of the adjustment to the one or more marshaling commands. As yet another example, the adjustment to the one or more marshaling commands is received in response to a disruption-related threshold being exceeded. It is understood that the disruption-related threshold can be any predefined value. As a further example, the adjustment to the one or more marshaling commands includes control-time-based marshaling, waypoints-based marshaling, message transmission rates, a velocity of the vehicle, a curvature of the traverse of the vehicle, a spacing buffer associated with the vehicle or a combination thereof.

In one or more embodiments, the analysis of the one or more marshaling-related characteristics is transmitted to the infrastructure system. For example, the analysis of the one or more marshaling-related characteristics is transmitted from the vehicle via a live communication link. As another example, the transmission of the analysis is simultaneous to the traverse of the vehicle across the marshaling environment.

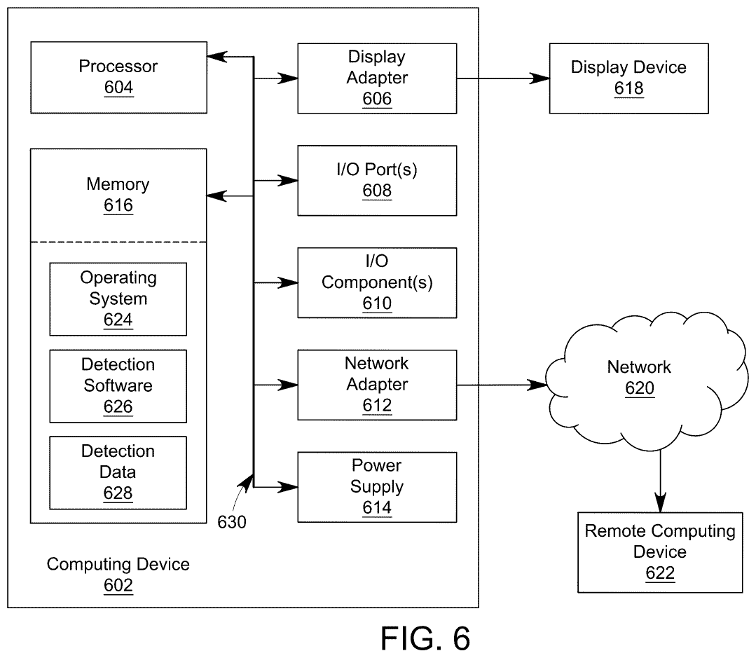

FIG. 6 illustrates an operating environment that facilitates the performance of the one or more systems and methods described herein. More specifically, the systems and methods described herein can be implemented using a computing device 602. For example, the computing device 602 can be a personal computer, a desktop, a laptop, a tablet, a hand-held computer, a server, a workstation, a mainframe, a wearable computer, a supercomputer, or a combination thereof. However, it is understood that the aforementioned examples of the computing device 602 is non-exhaustive and the computing device 602 can be any type of processing or computing device. The computing device 602 generally includes a processor 604, a display adapter 606, one or more input/output port(s) 608, one or more input/output component(s) 610, a network adapter 612, a power supply 614, and a memory 616. However, it is understood that the computing device 602 can include any additional components therein and is not required to include any of the listed components (e.g., the processor 604, the display adapter 606, the one or more input/output port(s) 608, the one or more input/output component(s) 610, the network adapter 612, the power supply 614, and the memory 616).

The processor 604 is configured to provide instructions to the computing device 602 so that the computing device 602 can process one or more tasks including the implementation of a software program to perform one or more operations as described in more detail herein. It is also understood that the computing device 602 may include any number or processors 604 therein. The display adapter 606 can be a graphics card or a video board that provides the computing device 602 with a capability to display content on a display device 618. For example, the display device 618 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of the display device 618 is non-exhaustive and that the display device 618 can be any type of device capable of providing a visual display.

The input/output port(s) 608 provide a number of interfaces (e.g., sockets) for one or more cables to connect to the computing device 602. It is understood that there may be any number of input/output port(s) 608 on the computing device 602. For example, the input/output port(s) 608 provides a means for the computing device 602 to receive signals and/or data from an external device connected to the computing device 602 via the one or more cables. As another example, the input/output port(s) 608 provide a means for the computing device 602 to send signals and/or data to an external device connected to the computing device 602 via the one or more cables. The input/output component(s) 610 can include one or more components that support the input/output port(s) 608 such as, but not limited to, a switch, a push button, a pressure mat, a float switch, a keypad, a radio receive, or a combination thereof.

The network adapter 612 can be any type of network interface controller that is configured to provide a means for communicating over a network 620 with another computing device, such as a remote computing device 622. For example, the remote computing device 622 can be a user device such as a cellular-phone, a smartphone, a tablet, a laptop, or a combination thereof. The power supply 614 is configured to convert alternating high voltage current (e.g., AC) into direct current (e.g., DC) to provide regulated power to the other components (e.g., the processor 604, the display adapter 606, the one or more input/output port(s) 608, the one or more input/output component(s) 610, the network adapter 612, and the memory 616) of the computing device 602.

Additionally, the memory 616 can be a mass storage device and/or a system memory such as a hard disk drive, a memory card, a solid-state drive, random access memory (RAM), or a combination thereof. The memory 616 is configured to provide storage for instructions and data associated with the operation of the computing device 602. The memory 616 can generally include an operating system 624, detection software 626, and detection data 628. For example, the operating system 624 is configured to manage and/or process any of the data and/or instructions associated with the detection software 626 and/or detection data 628, as described in more detail herein.

Furthermore, a system bus 630 is also included within the computing device 602 that is configured to couple each of the various components (e.g., the processor 604, the display adapter 606, the one or more input/output port(s) 608, the one or more input/output component(s) 610, the network adapter 612, the power supply 614, and the memory 616) of the computing device 602. It is also understood that each of the components of the computing device 602, and the functionality associated with each of the components of the computing device 602, may be implemented within the remote computing device 622. While the operating environment illustrated within FIG. 6 depicts a particular configuration associated with at least the computing device 602, the network 620, and the remote computing device 622, it is understood that the operating environment may be configured in any way.

Thus, one or more examples of the present disclosure provides a means for providing a consistently strong and/or reliable communication link to one or more marshaled vehicles with an infrastructure system based on real-time or live reporting of a condition of cellular connectivity within a marshaling environment. The present disclosure also provides one or more examples of how to prevent the one or more marshaled vehicles from traveling through any areas of the marshaling environment that have instances of interference and/or degradation present therein.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method comprising:
monitoring, by a vehicle-marshaling algorithm of a vehicle, one or more marshaling-related characteristics based on an exchange of one or more messages with an infrastructure system;
detecting at least one cellular-related disruption corresponding to a cell of a plurality of cells associated with a marshaling environment, wherein the detection of the at least one cellular-related disruption is associated with the one or more marshaling-related characteristics;
analyzing the one or more marshaling-related characteristics associated with the at least one cellular-related disruption based on one or more marshaling commands; and
receiving an adjustment to the one or more marshaling commands based on the analysis, wherein a traverse of the vehicle is adjusted based on the receipt of the adjustment to the one or more marshaling commands.

2. The method of claim 1, wherein the one or more marshaling-related characteristics include unicast wireless frequencies associated with the vehicle, a plurality of cell identifiers associated with the plurality of cells, radio frequency-related performance metrics, or a combination thereof.

3. The method of claim 1, wherein the at least one cellular-related disruption includes degradation of a live communication link between the vehicle and the infrastructure system, an interference associated with the live communication link, or a combination thereof.

4. The method of claim 1, further comprising:
transmitting, from the vehicle via a live communication link, the analysis of the one or more marshaling-related characteristics to the infrastructure system, wherein the transmission of the analysis is simultaneous to the traverse of the vehicle across the marshaling environment.

5. The method of claim 1, wherein the analysis of the one or more marshaling-related characteristics further comprises:
verifying a location of the vehicle based on coordinates of the location of the vehicle matching snap-shot data associated with the location of the vehicle, wherein the snap-shot data is obtained from one or more vehicle sensors; and
causing, in response to the verification of the location of the vehicle, a time-stamp and a virtual dynamic radio-frequency coverage heat map of the at least one cellular-related disruption to be generated.

6. The method of claim 1, wherein the adjustment to the one or more marshaling commands is received in response to a disruption-related threshold being exceeded.

7. The method of claim 1, wherein the adjustment to the one or more marshaling commands includes control-time-based marshaling, waypoints-based marshaling, message transmission rates, a velocity of the vehicle, a curvature of the traverse of the vehicle, a spacing buffer associated with the vehicle or a combination thereof.

8. A system comprising:
a vehicle system configured to:
monitor, by a vehicle-marshaling algorithm of a vehicle, one or more marshaling-related characteristics based on an exchange of one or more messages with an infrastructure system,
detect at least one cellular-related disruption corresponding to a cell of a plurality of cells associated with a marshaling environment, wherein the detection of the at least one cellular-related disruption is associated with the one or more marshaling-related characteristics,
analyze the one or more marshaling-related characteristics associated with the at least one cellular-related disruption based on one or more marshaling commands, and
receive an adjustment to the one or more marshaling commands based on the analysis, wherein a traverse of the vehicle is adjusted based on the receipt of the adjustment to the one or more marshaling commands;
the infrastructure system configured to:
receive the analysis of the one or more marshaling-related characteristics,
generate a time-stamp and a virtual dynamic radio-frequency coverage heat map of the at least one cellular-related disruption, and
transmit the one or more adjustments to the one or more marshaling commands to the vehicle system; and
a mobile network operator configured to:
receive the analysis of the one or more marshaling-related characteristics via an original equipment manufacturing cloud system, and
repair the at least one cellular-related disruption.

9. The system of claim 8, wherein the one or more marshaling-related characteristics are analyzed via one or more of latency one-way, round-trip time, inter-packet gap, congestion, reference-signal-received-power, reference-signal-received-quality, signal-to-interference-plus-noise-ratio, interference, packet-loss, through-put, start-and-end associated with physical cell identifiers, frequency channels and bands monitoring indoors and outdoors, cell identifiers, start-and-end evolved-node-Bs, and wherein the one or more marshaling-related characteristics include unicast wireless frequencies associated with the vehicle, a plurality of cell identifiers associated with the plurality of cells, radio frequency-related performance metrics, or a combination thereof.

10. The system of claim 8, wherein the at least one cellular-related disruption includes degradation of a live communication link between the vehicle and the infrastructure system, an interference associated with the live communication link, or a combination thereof.

11. The system of claim 8, wherein the vehicle system is further configured to:
transmit, from the vehicle via a live communication link, the analysis of the one or more marshaling-related characteristics to the infrastructure system, wherein the transmission of the analysis is simultaneous to the traverse of the vehicle across the marshaling environment.

12. The system of claim 8, wherein the vehicle system configured to analyze the one or more marshaling-related characteristics is further configured to:
verify a location of the vehicle based on coordinates of the location of the vehicle matching snap-shot data associated with the location of the vehicle, wherein the snap-shot data is obtained from one or more vehicle sensors; and
cause, in response to the verification of the location of the vehicle, a time-stamp and a virtual dynamic radio-frequency coverage heat map of the at least one cellular-related disruption to be generated.

13. The system of claim 8, wherein the adjustment to the one or more marshaling commands is received in response to a disruption-related threshold being exceeded.

14. The system of claim 8, wherein the adjustment to the one or more marshaling commands includes control-time-based marshaling, waypoints-based marshaling, message transmission rates, a velocity of the vehicle, a curvature of the traverse of the vehicle, a spacing buffer associated with the vehicle or a combination thereof.

15. One or more non-transitory computer-readable media storing processor-executable instructions that, when executed by at least one processor, cause the at least one processor to:
monitor, by a vehicle-marshaling algorithm of a vehicle, one or more marshaling-related characteristics based on an exchange of one or more messages with an infrastructure system;
detect at least one cellular-related disruption corresponding to a cell of a plurality of cells associated with a marshaling environment, wherein the detection of the at least one cellular-related disruption is associated with the one or more marshaling-related characteristics;
analyze the one or more marshaling-related characteristics associated with the at least one cellular-related disruption based on one or more marshaling commands; and
receive an adjustment to the one or more marshaling commands based on the analysis, wherein a traverse of the vehicle is adjusted based on the receipt of the adjustment to the one or more marshaling commands.

16. The one or more non-transitory computer-readable media of claim 15, wherein the one or more marshaling-related characteristics are analyzed via one or more of latency one-way, round-trip time, inter-packet gap, congestion, reference-signal-received-power, reference-signal-received-quality, signal-to-interference-plus-noise-ratio, interference, packet-loss, through-put, start-and-end associated with physical cell identifiers, frequency channels and bands monitoring indoors and outdoors, cell identifiers, start-and-end evolved-node-Bs, and wherein the one or more marshaling-related characteristics include unicast wireless frequencies associated with the vehicle, a plurality of cell identifiers associated with the plurality of cells, radio frequency-related performance metrics, or a combination thereof.

17. The one or more non-transitory computer-readable media of claim 15, wherein the at least one cellular-related disruption includes degradation of a live communication link between the vehicle and the infrastructure system, an interference associated with the live communication link, or a combination thereof.

18. The one or more non-transitory computer-readable media of claim 15, wherein the at least one processor is further caused to:
transmit, from the vehicle via a live communication link, the analysis of the one or more marshaling-related characteristics to the infrastructure system, wherein the transmission of the analysis is simultaneous to the traverse of the vehicle across the marshaling environment.

19. The one or more non-transitory computer-readable media of claim 15, wherein the at least one processor caused to analyze the one or more marshaling-related characteristics is further caused to:
verify a location of the vehicle based on coordinates of the location of the vehicle matching snap-shot data associated with the location of the vehicle, wherein the snap-shot data is obtained from one or more vehicle sensors; and
cause, in response to the verification of the location of the vehicle, a time-stamp and a virtual dynamic radio-frequency coverage heat map of the at least one cellular-related disruption to be generated.

20. The one or more non-transitory computer-readable media of claim 15, wherein the adjustment to the one or more marshaling commands is received in response to a disruption-related threshold being exceeded, and wherein the adjustment to the one or more marshaling commands includes control-time-based marshaling, waypoints-based marshaling, message transmission rates, a velocity of the vehicle, a curvature of the traverse of the vehicle, a spacing buffer associated with the vehicle or a combination thereof.
